(19) United States
(12) Patent Application Publication
(10) Pub. No.: US 2008/0124467 A1
(43) Pub. Date: May 29, 2008

(54) Modified surfaces and method for modifying a surface

(76) Inventors: Jean-Paul Chapel, Princeton, NJ (US); Ashwin Rao, Norristown, PA (US); Zhengang Zong, Pennington, NJ (US)

Correspondence Address: KEVIN E. MC VEIGH;RHODIA INC., CN 7500, 8 CEDAR BROOK DRIVE, CRANBURY, NJ, 08512-7500, US

(21) Appl. No.: 11/729,376

(22) Filed: Mar. 28, 2007

Related U.S. Application Data
(60) Provisional application No. 60/787,369, filed on Mar. 30, 2006.

(51) Int. Cl. B05D 3/00; B32B 9/00; B32B 15/00; B32B 15/06; B32B 27/28

(52) U.S. Cl. 427/331; 428/688; 428/457; 428/421; 428/461

(57) ABSTRACT

A surface modified substrate includes a substrate having a surface and a layer of nanoscale inorganic oxide particles disposed on at least a portion of the surface.

### FIELD OF THE INVENTION

This invention relates to a modified surfaces and to a method for modifying a surface.

### BACKGROUND OF THE INVENTION

Some materials, particularly polymers and ceramics, are used in applications where interactions between their surfaces with other materials are important. Surface chemical and physical properties are of primary importance in many applications, such as catalysis and drug delivery, and can be an important factor in many engineering design considerations, such as adhesion. There are known techniques, such as plasma treatment and corona discharge for modifying the chemical and/or physical properties of the surface of a substrate. However, in many cases, such as modification of polymer surfaces, the effects of high energy treatments tend to dissipate over time and the surface modification imparted thereby is of limited durability.

Accordingly, there is a need more durable surface modification techniques.

### SUMMARY OF THE INVENTION

In a first aspect, the present invention is directed to a surface modified substrate, comprising a substrate having a surface and a layer of nanoscale inorganic oxide particles disposed on at least a portion of the surface.

In a second aspect, the present invention is directed to a method for modifying the surface of a substrate, comprising treating such at least a portion of such surface with a slurry of nanoscale inorganic oxide particles to deposit a quantity of such particles on such portion of such surface.

### BRIEF DESCRIPTION OF THE DRAWINGS

FIG. 1 shows a comparison, following rinsing with water, of images printed on two poly(ethylene terephthalate) substrates, that is, a first substrate that had been treated with a slurry of nanoscale inorganic oxide particles prior to printing (“Treated”), and a second substrate that had not been treated a slurry of nanoscale inorganic oxide particles prior to printing (Non-treated”).

FIG. 2 shows a plot of the concentration of adsorbed cerium oxide particles versus contact time with two cerium oxide nanoparticle sols, a first sol that contained 0.03M NaNO₃ and a second sol that lacked the NaNO₃ component.

### DETAILED DESCRIPTION OF INVENTION

The modification process of the present invention is not sensitive to the surface chemical and physical properties of the substrate and the substrate of the present invention may be any solid material.

In one embodiment, the substrate is an organic polymer, an organosilicon polymer, a ceramic, a metal, a composite material, or an inorganic material other than a ceramic or metal. Suitable organic polymers include homopolymers, random copolymers, block copolymers, and polymer blends such as polyolefins, such as polyethylene, polypropylene, and polystyrene, polyacrylates, such as polymethylmethacrylate, halogenated polymers, such a polytetrafluoroethylene, conducting polymers such as polyacetylenes, polypyrroles, polythiophenes, polyanilines, polyfluorenes, poly(3-hexylthiophene), polynaphthalenes, poly(p-phenylene sulfide), poly(para-phenylene vinylene)s, engineering plastics such as polyamides, poly(ether ketones), polyimides, polycarbonates, polyesters and polyurethanes. Suitable organosilicon polymers include, for example, polydimethylsiloxane. Suitable ceramics include, for example, alumina, zirconia, silica, silicone carbide, silicon nitride. Suitable metals include chromium, aluminum, iron, nickel, copper, platinum, paladium, gold and alloys of the above metals. Suitable composites include, for example, fiber or particle reinforced polymers, such as silica filled ethylene propylene diene rubber, carbon nanotube-polymer composites and metal particulate-filled polymers. Additional substrates also include materials such as fused glass, quartz, calcium fluoride, mica, silicon, germanium and indium tin oxide

The substrate may be of any physical configuration, such as a shaped article, including for example, fibers, flat or shaped sheets, hollow tubes, spheres, or as a layer, which may be continuous or discontinuous, supported on a second substrate..

In one embodiment, the surface of the substrate has a root mean square (“RMS”) surface roughness of less than about 200 nm, more typically from about 100 to about 200 nm.

In one embodiment the substrate has an RMS surface roughness of less than about 10 nm, more typically less than about 2 nm.

As used herein the terminology “primary particle” means a single discrete particles and the terminology “secondary particle” means an agglomerate of two or more primary particles. A reference to “particles” that does not specify “primary” or “secondary” means primary particles, or secondary particle, or primary particles and secondary particles.

As used herein, the term “nanoscale” in reference to particles means that the particles have a mean particle diameter (“D₅₀”) of from about 1 to about 1000 nanometers (“nm”). In one embodiment, the nanoscale primary particles have a D₅₀ of from about 5 to about 1000 nm, even more typically from about 10 to about 800 nm, and still more typically from about 20 to about 500 nm. In one embodiment, the nanoscale primary particles have a D₅₀ of from about 1 to about 500 nm, even more typically from about 1 to about 100 nm, and still more typically from about 1 to about 50 nm. Particle size may be determined using dynamic light scattering.

Suitable inorganic oxides include oxides of single elements, such as cerium oxide, titanium oxide, zirconium oxide, halfnium oxide, tantalum oxide, tungsten oxide and bismuth oxide, zinc oxide, indium oxide, and tin oxide, iron oxide, and mixtures of such oxides, as well as oxides of mixtures of such elements, such as cerium-zirconium oxides.

The inorganic oxide particles may further comprise linked or absorbed ions, such as, for example, metal ions, nitrate ions.

In one embodiment, the inorganic oxide is a crystalline solid. More typically, aqueous sols of particles of the inorganic oxide are stabilized by electrostatic charges and/or hydrostatic forces and subject to destabilization by perturbations of pH, ionic strength, and concentration. Such inorganic oxides are typically synthesized under highly acidic or highly basic reaction conditions.

In one embodiment, the inorganic oxide is selected from iron oxide, zirconium oxide and cerium oxide. More typically, the inorganic oxide is cerium oxide.

Methods for making suitable inorganic oxide particles are known, such as sol-gel techniques, direct hydrolysis of metal alkoxides by water addition, forced hydrolysis of metal salts or by reaction of metal alkoxides with metal halides.

In one embodiment, the nanoscale inorganic oxide particles are made by precipitation of a cerium salt.

In one embodiment, the nanoscale inorganic oxide particles are initially present in the form of a sol, also termed a “slurry”, of such particles dispersed in an aqueous medium. Typically, the aqueous medium comprises at least 40 wt %, more typically at least 50 wt % water and even more typically at least 60 wt % water. In one embodiment, the aqueous medium consists essentially of water. The aqueous medium may optionally further comprise one or more water miscible organic liquids, such as for example, tetrahydrofuran, N,N-dimethylformamide, acetonitrile, acetone, (C₁-C₈)alkanols such as methanol, ethanol, 2-propanol and diols such as ethylene glycol or, propylene glycol.

In one embodiment, the aqueous medium of the sol comprises, based on 100 parts by weight (“pbw”) of such aqueous medium, from about 0 to about 100 pbw, more typically from about 40 to about 100 pbw, and still more typically from about 50 to about 100 pbw water, and from 0 to about 90 pbw, more typically from 0 to about 60 pbw, and still more typically from about 0 to about 50 pbw, of one or more water miscible organic liquids.

The sol exhibits, at least initially, a pH effective to provide a stable sol, that is, a sol wherein the nanoscale inorganic oxide particles tend to remain dispersed in the aqueous medium. In one embodiment, the nanoscale inorganic oxide particle slurry is a stable slurry that comprises nanoscale cerium oxide particles and exhibits a pH of less than or equal to about 2. In another embodiment, the nanoscale inorganic oxide particle slurry is a stable slurry that comprises nanoscale silicon oxide particles and exhibits a pH of from about 7.5 to about 8.5.

In one embodiment, nanoscale inorganic oxide particles are deposited on a surface of the substrate by contacting the surface with a stable nanoscale inorganic oxide particle sol and then adjusting the pH of the sol to destabilize the sol and cause precipitation of nanoscale inorganic oxide particles from the sol onto the surface.

In one embodiment, the sol comprises, based on the total weight of the sol, from greater than 0 to about 10 percent by weight (wt % ″), more typically from about 0.01 to about 5 percent by weight nanoscale inorganic oxide particles. In one embodiment, the sol comprises from about 0.01 to about 1.0 wt %, and still more typically from about 0.01 to about 0.5 wt %, nanoscale inorganic oxide particles.

In one embodiment, the pH of the stable sol is initially less than or equal to about 2, more typically less than or equal to about 1.5, and is adjusted to a value from about 3 to about 14, more typically from about 4 to about 12, and even more typically from about 5 to about 8, to precipitate the nanoscale inorganic particles from the sol.

In one embodiment, the pH of the stable sol is initially greater than or equal to about 10, more typically greater than or equal to about 11, and is adjusted to a value of about 1 to about 9, more typically from about 4 to about 9, and even more typically from about 5 to about 8, to precipitate the nanoscale inorganic particles from the sol.

In one embodiment, the aqueous medium of the sol further comprises a dissolved electrolyte, in an amount effective to encourage deposition of particles from the sol onto the surface of the substrate without destabilizing the sol. While not wishing to be bound by theory, it is believed that the presence of the electrolyte reduces electrostatic interactions among the nanoscale inorganic oxide particles of the sol and prevents the buildup of an electrostatic charge as nanoscale inorganic oxide particles deposit from the sol onto the surface of the substrate. In one embodiment, the effective amount of electrolyte is from greater than 0 to about 1 pbw, more typically from about 0.01 to about 0.1 pbw electrolyte, per 100 pbw of the aqueous medium, that is, of the combined amount of the water and any water miscible organic liquid components of the sol.

Suitable electrolytes are those that do not destabilize the sol when present in an amount effective to encourage deposition of particles from the sol onto the surface of the substrate and include organic salts, inorganic salts, and mixtures thereof. The electrolyte typically comprises a salt having a cationic component and an anionic component. Suitable cations may be monovalent or multivalent, may be organic or inorganic, and include, for example, sodium, potassium, lithium, calcium, magnesium, cesium, and lithium cations, as well as mono-, di- tri- or quaternary ammonium or pyridinium cation. Suitable anions may be a monovalent or multivalent, may be organic or inorganic, and include, for example, chloride, sulfate, nitrate, nitrite, carbonate, citrate, cyanate acetate, benzoate, tartarate, oxalate, phosphate, and phosphonate anions. Suitable electrolytes include, for example, salts of multivalent anions with monovalent cations, such as potassium pyrophosphate, potassium tripolyphosphate, and sodium citrate, salts of multivalent cations with monovalent anions, such as calcium chloride, calcium bromide, zinc halides, barium chloride, and calcium nitrate, and salts of monovalent cations with monovalent anions, such as sodium chloride, potassium chloride, potassium iodide, sodium bromide, ammonium bromide, alkali metal nitrates, and ammonium nitrates.

In one embodiment the electrolyte comprises one or more of salts of multivalent anions with monovalent cations and monovalent cations with monovalent anions.

In one embodiment, the electrolyte comprises a monovalent cationic component and a monovalent or multivalent anionic component. In one embodiment, the electrolyte comprises a nitrate salt. Suitable nitrate salts include alkali metal nitrate salts, such as sodium nitrate and potassium nitrate, as well as ammonium nitrate, or a mixture thereof.

In one embodiment, the stable nanoscale inorganic oxide particle sol that contains an electrolyte and nanoscale inorganic oxide particles are deposited from the sol onto a surface of a substrate by contacting the surface with the stable electrolyte-containing nanoscale inorganic oxide particle sol.

In one embodiment, the sol is a stable electrolyte-containing nanoscale cerium oxide particle sol and exhibits a pH that is less than or equal to about 2, more typically less than or equal to about 1.5.

The surface of the substrate is contacted with the stable electrolyte-containing nanoscale inorganic oxide particle sol and the surface is subsequently rinsed in an aqueous rinse solution.

In one embodiment, the surface of the substrate is contacted with the sol by immersing the substrate in the sol.

The surface of the substrate is contacted with the sol for a period of time effective to allow deposition of a quantity of nanoscale inorganic oxide particles from the sol onto at least a portion of the surface the substrate. For a given sol, longer contact time typically results in deposition of a greater quantity of particles from the sol onto the surface of the substrate. In one embodiment, sufficient contact time is any time greater than 0 seconds, more typically from greater than 0 seconds to about 100 hours. In one embodiment, the contact time is from greater than 0 seconds to about 24 hours, more typically from greater than or equal to about 1 second to about 5 hours, and even more typically from about 10 seconds to about 1 hour.

In general, the time period between discontinuing contact of the treated surface with the sol and rinsing the treated surface is not critical. In one embodiment, the treated surface is rinsed to remove any poorly adhered nanoscale inorganic oxide particles from the treated surface. Typically, contact of the surface with the sol is discontinued and the surface is rinsed with the aqueous rinse solution immediately or substantially immediately after the contact of the surface with the sol is discontinued. Optionally, the treated surface may be allowed to dry during the time period after contact of the surface with the sol is discontinued and prior to rinsing.

The aqueous rinse solution comprises water and may, optionally, further comprise up to about 70 wt %, more typically up to about 30 wt %, of a water miscible organic liquid.

In one embodiment, the rinse solution further comprises an electrolyte in an amount effective to discourage desorption of the deposited nanoscale inorganic oxide particles from the treated surface, which is typically from greater than 0 to about 1 wt %, more typically from about 0.01 wt % to about 0.1 wt %, of an electrolyte.

The pH of the rinse solution is not critical. In one embodiment, wherein the nanoscale inorganic oxide particles of the sol are nanoscale cerium oxide particles, the rinse solution exhibits a pH of greater than or equal to 7, more typically, from 7 to about 12, and is more typically from about 10 to about 12.

In one embodiment, the layer of nanoscale particles on the surface is a monolayer. As used herein in reference to nanoscale inorganic particles, the term “monolayer” of means a layer that is one particle thick.

In one embodiment, the layer of nanoscale particles on the hydrophobic surface is a discontinuous layer of particles. As used herein in reference to a layer of particles, the term “discontinuous” means that the layer includes regions of void space defined between discrete particles and/or between regions of more closely packed particles.

In one embodiment, the layer of nanoscale particles on the hydrophobic surface is an at least substantially continuous layer of particles. As used herein in reference to a monolayer of particles, the term “continuous” means that the particles of the layer are closely packed so that a typical particle of the layer is substantially surrounded by and in contact with other particles of the layer.

In one embodiment, the substrate containing the deposited inorganic particles may be annealed for extended periods of time at temperatures between 298° K and 773° K, more typically between 298° K and 473° K and even more typically between 298° K and 298° K in an environment that may or may not be saturated with water vapor

The inorganic oxide particles may comprise surface hydroxyl groups available to undergo condensation with hydroxyl groups of adjacent particles of the layer to form covalent bonds between such particles.

In one embodiment, the layer of nanoscale particles on the surface is an at least substantially continuous monolayer of particles, wherein a typical particle of the layer is substantially surrounded by, in contact with, and bonded to other particles of the monolayer.

The layer of nanoscale inorganic oxide particles modifies the chemical and/or physical properties, for example, the chemical reactivity and/or the surface energy, of the surface modified substrate of the present invention.

In one embodiment, the surface modified substrate is a hydrophilized substrate, comprising a substrate initially having a hydrophobic surface and a layer of nanoscale inorganic oxide particles disposed on at least a portion of such hydrophobic surface in an amount effective to increase the hydrophilicity of such portion of such hydrophobic surface.

As used herein, “hydrophobic surface” means a surface that exhibits a tendency to repel water and to thus resist being wetted by water, as evidenced by a contact angle with water of greater than or equal to 70°, more typically greater than or equal to 90°, “hydrophilic surface” means a surface that exhibits an affinity for water and to thus be wettable by water, as evidenced by a contact angle with water of less than 70°, more typically less than 60°, and even more typically less than 20°, and “hydrophilizing” a hydrophobic surface means rendering the surface more hydrophilic and thus less hydrophobic, as indicated by a decreased contact angle with water, wherein in each case, the contact angle with water is measured by a conventional image analysis method, that is, by disposing a droplet of water on the surface, typically a substantially flat surface, at 25° C., photographing the droplet, and measuring the contact angle shown in the photographic image.

One indication of increased hydrophilicity of a treated hydrophobic surface is a decreased contact angle of water droplets with a treated surface compared to the contact angle of water droplets with an untreated surface. Water droplet contact angle is awkward to determine with respect to a typical fiber due to the fiber surface configuration, which is due to the lack of a substantially flat surface. A water droplet contact angle measurement that is representative of the fiber surface can conveniently be made using a flat sheet or sample coupon of same material as the fiber of interest. Typically, the treated surface exhibits a water droplet contact angle of less than 70°, more typically less than 60°, even more typically, less than 45°.

In one embodiment, an untreated hydrophobic substrate having an advancing water drop contact angle (θₐ) of greater than or equal to about 70°, more typically greater than or equal to 80° and following surface modification according to the present invention exhibits an advancing water contact angle (θₐ) of less than or equal to about 40°, more typically less than or equal to about 20°, and a receding water contact angle (θᵣ) of less than or equal about 60°, more typically less than or equal to about 45°.

The hydrophilic properties imparted by surface modification according to the present invention are quite durable and hydrophilically modified substrates according to the present invention maintain a θₐ of less than 45° and a θᵣ of less than 20° following treatment. This is in contrast to hydrophobic recovery of the amorphous region for polymers such as polypropylene that is typically seen after classic treatments, such as plasma and bulk functionalization. The organic oxide layer of the surface modified substrate of the present invention layer acts as if strongly anchored to the underlying surface and cross-linked in the oxide layer plane, apparently hindering any free energy minimization-driven reorganization of the underlying surface.

Suitable substrates having hydrophobic surfaces include polyolefin substrates, such as polyethylene, polypropylene, and polystyrene, polyacrylate substrates, such as polymethylmethacrlate, halogenated polymer substrates, such as polytetrafluroethylene, and organosilicon polymer substrates such as polydimethylsiloxane.

In one embodiment, the substrate is a polyolefin sheet or shaped polyolefin article, such as, for example, a component of an automobile.

In one embodiment, the surface modified substrate is coated with water borne coating, such as a vinyl latex coating or an acrylic latex coating, and the layer of nanoscale inorganic oxide particles allows application of a continuous layer of water borne coating on the hydrophobic surface of the substrate and typically improves the adhesion of the coating to the substrate.

In one embodiment, the substrate comprises a fabric substrate comprising a plurality of fibers. As used herein, the term “fiber” means a generally elongated article having a characteristic longitudinal dimension, typically a “length”, and a characteristic transverse dimension, typically a “diameter” or a “width”, wherein the ratio of the characteristic longitudinal dimension to the characteristic transverse dimension is greater than or equal to about 50, more typically greater than or equal to about 100.

Suitable fibers are those that have a hydrophobic surface and are typically hydrophobic synthetic polymer fibers, such as polyacrylonitrile fibers, poly(ethyleneterephthalate) fibers, and poly(olefin) fibers, such as, for example, poly(ethylene) fibers or poly(propylene) fibers.

In one embodiment, the surface modified substrate of the present invention exhibits increases reactivity comprising a substrate initially having a relatively chemically inert surface and a layer of nanoscale inorganic oxide particles disposed on at least a portion of such surface in an amount effective to increase the chemically reactivity of such portion of such surface. For example, the layer of nanoscale inorganic oxide particles disposed on at least a portion of the surface of relatively inert substrate introduces reactive hydroxyl functional groups onto the surface.

In one embodiment, the surface modified substrate is coated with a layer of an organic coating, such as an adhesive or an organic solvent based coating and the layer of nanoscale inorganic oxide particles improves the adhesion of the organic layer to the substrate.

### EXAMPLE 1

Thin silicon wafers (from Wafer World Inc, 1 side polished, (100) are covered with a native silicon oxide (SiO₂) layer of approximately 2 nm (by ellipsometry). The substrate was dipped into a 0.1 wt % aqueous sol of nanoscale cerium oxide particles at pH about equal to 1.5 for 10 minutes. The cerium oxide particles of the sol exhibited an average particle size of about 10 nanometers by dynamic light scattering measurement. The pH was then increased to pH about equal to 10 by adding NH₄OH. The substrate was then rinsed thoroughly with pure deionized water to remove any non-adsorbed material. The substrate was then dried under nitrogen flow and contact angles were measured.

Advancing contact angles (θₐ) were around 45°. Receding contact angles (θᵣ) were below 15-20°. AFM (atomic force microscopy) and ellipsometry measurements have shown that the layer was indeed a homogenous monolayer of nanoceria (thickness about equal to 6-10 nm). After 1 month, the contact angles remained the same ((θₐ about equal to 45°, θᵣ about equal to 15-20°).

### EXAMPLE 2

Polystyrene is an amorphous, glassy (T_{g}≈100° C.) and hydrophobic (θₐ≈90°) polymer. Spin-coating was used to obtain a smooth model polystyene layer (RMS about equal to 1 nm on 1×1 μm² area) from an organic solution (2.5 wt % in toluene) onto a silicon wafer. Final thickness was about 100 nm.

The samples of polystyrene coated substrate were treated with nanoceria according to the same procedure as described above in Example 1.

Advancing contact angles (θₐ) were around 45°. Receding contact angles (θᵣ) were below 15-20. AFM measurements have shown that the layer was indeed a homogenous monolayer of nanoceria (thickness about equal to 6-10 nm). After 1 month, the contact angles remained the same ((θₐ about equal to 45°, θᵣ about equal to 15-20°).

### EXAMPLE 3

Polypropylene is a semi-crystalline, rubbery (T_{g} about equal to −20° C.) and hydrophobic (θₐ≈105°) polymer. Spin-coating was used to obtain a smooth model polypropylene layer (RMS about equal to 2 nm on 1×1 μm² area) from an organic solution (2.5 wt % in hot xylene) onto a silicon wafer. Final thickness was about 100 nm.

The samples of polypropylene coated substrate were treated with nanoceria according to the same procedure as described above in Example 1.

Advancing contact angle (θₐ) were around 45°. Receding contact angles (θᵣ) were below 15-20°. AFM measurements have shown that the layer was indeed a homogenous monolayer of nanoceria (thickness about equal to 6-10 nm). After 1 month, the contact angles remained the same (θₐ about equal to 45°, θᵣ about equal to 15-20°).

### EXAMPLE 4

Surface modified substrates according to Example 1 were soaked overnight in each of three different respective organosilane solutions (octadecyltrichlorosilane 99.9% (ALDRICH), heptadecafluoro-1,1,2,2-tetrahydrodecyl-dimethylchlorosilane (GELEST Inc), and n-octyltrimethoxysilane (GELEST Inc)., each 1.7 wt % in hexane).

In each case, after a thorough rinsing in hot hexane to get rid of non-chemisorbed molecules, contact angles were measured. Advancing contact angles (θₐ) following each of the three silane treaments were greater than 105°, showing likely a reaction between the silane molecules and the hydroxyl groups present on the ceria monolayer surface.

### EXAMPLE 5

Pure ethanol (pH about equal to 9.8) was acidified by adding HNO₃ to a pH about equal to 1.5. A 1 wt % sol of nanoscale cerium oxide particles dispersed in water (pH about equal to 1.5) was diluted with the previous ethanol solution to get a 50:50 V:V sol at a cerium oxide particle concentration of 0.1 wt %. The cerium oxide particles of the sol exhibited an average particle size of about 10 nanometers by dynamic light scattering measurement. Such a sol has a surface tension of about 30 milliNewtons per meter (mN/m) (pure water being about 72 mN/m).

Polyethylene sheets (2 cm×1 cm×1 mm) were dipped in the sol (because polyethylene has a critical surface tension γ_{c} of about 32 mn/m, the solution completely wet the substrate) and withdrawn after 10 seconds and then immediately dipped into pure deionized water (pH about equal to 6) to precipitate the sol. The substrate was then rinsed thoroughly and dried under a nitrogen flow. Contact angles were measured the following day. Advancing contact angles (θₐ) were about 45°. Receding contact angles (θᵣ) were below 15-20°.

### EXAMPLE 6

A 0.1 wt % sol of nanoscale cerium oxide particles dispersed in deionized water was prepared and acidified to pH 1.5 with nitric acid. The cerium oxide particles of the sol exhibited an average particle size of about 10 nanometers by dynamic light scattering measurement Polystyrene sample plaques were treated by submerging the plaques in the dispersion for 10 minutes. The pH was then increased to 9 by adding NH₄OH. After 10 minutes of soaking, the sample plaques were removed and rinsed with deionized water at pH 1.5.

After drying, the hydrophilicity of the treated surfaces of the plaques was tested. The treated plaques were cleaned with isopropyl alcohol and the wet plaques were then placed vertically and sprayed with tap water with a spray bottle. Every two sprays were counted as 1 rinse cycle. The test would conclude when either 70% of the tile would begin to bead (returning to hydrophobicity) or 20 cycles of water sheeting.

The treated plaques showed long lasting hydrophilization. Although the water sheeting was not even (pockets of water beading were always present), the areas that were hydrophilic remained hydrophilic even under harsh rinses at 7.5 L/min.

### EXAMPLE 7

A 0.1 wt % sol of nanoscale cerium oxide particles dispersed in deionized water was prepared and acidified to pH 1.5 with nitric acid. The cerium oxide particles of the sol exhibited an average particle size of about 10 nanometers by dynamic light scattering measurement The solution was further modified by the addition of 0.1 M sodium nitrate. Addition of salt did not change the dispersability of the nanoparticles. Polypropylene sample plaques were treated by submerging the plaques in the dispersion for 5 minutes. These plaques were then removed from the solution and rinsed in deionized water whose pH was adjusted to 11 by adding NH₄OH. After rinsing the substrate was air dried and the hydrophilicity of the treated surfaces of the plaques was tested using contact angle measurements. Advancing contact angles (θₐ) were about 101°. Receding contact angles (θᵣ) were below 26°.

### EXAMPLE 8

In a first step, poly(ethylene terephthalate) (PET) slides were dipped in a 0.1 wt % sol of nanoscale cerium oxide particles dispersed in water at pH about equal to 1.5 for a couple of hours and rinsed with pure DI water (pH about equal to 5.6) and stored in a laminar flow hood until complete dryness. The cerium oxide particles of the sol exhibited an average particle size of about 10 nanometers by dynamic light scattering measurement After such a treatment, the PET surface became hydrophilic leading to the formation of a stable wetting film when withdrawn from a water bath (receding contact angle <20°).

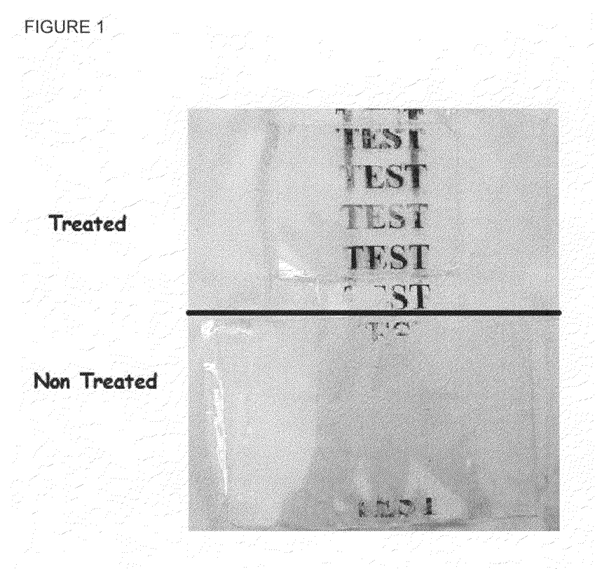

In a second step, adhesion of water born ink on treated and non treated PET tested using a regular Inkjet printer. Right after printing, both types of slides were rinsed using hot running water for 1 minute. The results of the test are shown in FIG. 1. On the non-treated surface, flowing hot water causes the ink to run off instantaneously while the ink on the nanoparticle treated surface is more resilient to the flowing water.

### EXAMPLE 9

A 0.1 wt % sol of nanoscale cerium oxide particles dispersed in deionized water was prepared and acidified to pH 1.5 with nitric acid. The cerium oxide particles of the sol exhibited an average particle size of about 10 nanometers by dynamic light scattering measurement The solution was further modified by the addition of 0.1 M sodium nitrate. Addition of salt did not change the dispersability of the nanoparticles. Aluminum sample plaques were treated by submerging the plaques in the dispersion for 5 minutes. These plaques were then removed from the solution and rinsed in deionized water After rinsing the substrate was air dried and aged for 1 week. The plaques were then coated with an acrylic latex paint and then subjected to a cross-hatch test (ASTM D3359-02) to evaluate the adhesion of the coating on aluminum. As a control, adhesion tests of the same coating material was performed Aluminum sample plaques were immersed in nitric acid solutions at pH 1.5 for 5 minutes, rinsed in deionized water and aged in air for identical periods of time as the nanoparticle treated aluminum plaques.

The results of the test are summarized below

| | % Coated Area | ASTM |
|---|---|---|
| Sample | Removed | Classification |
| Untreated Aluminum Plaque | 100 | 0B |
| Control Sample | 100 | 0B |
| Test Sample | 37 | 1B |

As seen from the test results, the adsorption of the nanoparticles enhanced the adhesion of the latex paint onto aluminum.

### EXAMPLE 11

A 0.1 wt % sol of nanoscale silicon oxide particles dispersed in deionized water was prepared and acidified to pH 3 with nitric acid. The silicon dioxide particles of the sol exhibited an average particle size of about 9 nanometers by dynamic light scattering measurement The solution was further modified by the addition of 0.1 M sodium nitrate. Addition of salt did not change the dispersability of the nanoparticles. Polypropylene sample plaques were treated by submerging the plaques in the dispersion for 2 hours. These plaques were then removed from the solution and rinsed in deionized water. After rinsing the substrate was air dried and the hydrophilicity of the treated surfaces of the plaques was tested using contact angle measurements.

Receding contact angle (θᵣ) of water on polypropylene plaques treated with silicon oxide nanoparticles in the presence of NaNO₃ was 34° while the receding contact angle of water on polypropylene plaques treated with silicon oxide nanoparticles without any NaNO₃ was 47 degrees. The receding contact angle of water on an untreated polypropylene plaque was 76°.

### EXAMPLE 12

A 0.1 wt % sol of nanoscale cerium oxide particles dispersed in deionized water was prepared and acidified to pH 1.5 with nitric acid. The cerium oxide particles of the sol exhibited an average particle size of about 10 nanometers by dynamic light scattering measurement The solution was further modified by the addition of 0.1 M sodium nitrate. Addition of salt did not change the dispersability of the nanoparticles. Polycarbonate sample plaques were treated by submerging the plaques in the dispersion for 1 hour. These plaques were then removed from the solution and rinsed in deionized water. After rinsing the substrate was air dried and the hydrophilicity of the treated surfaces of the plaques was tested using contact angle measurements.

Receding contact angle (θᵣ) of water on polycarbonate plaques treated with cerium oxide nanoparticles in the presence of NaNO₃ was 39° while the receding contact angle of water on untreated polycarbonate plaques was 60°.

### EXAMPLE 13

A 0.1 wt % sol of nanoscale cerium oxide particles dispersed in deionized water was prepared and acidified to pH 1.5 with nitric acid. The cerium oxide particles of the sol exhibited an average particle size of about 10 nanometers by dynamic light scattering measurement The solution was further modified by the addition of 0.1 M sodium nitrate. Addition of salt did not change the dispersability of the nanoparticles. Nylon 6,6 sample plaques were treated by submerging the plaques in the dispersion for 1 hour. These plaques were then removed from the solution and rinsed in deionized water. After rinsing the substrate was air dried and the hydrophilicity of the treated surfaces of the plaques was tested using contact angle measurements.

Receding contact angle (θᵣ) of water on Nylon 6,6 plaques treated with cerium oxide nanoparticles in the presence of NaNO₃ was 24° while the receding contact angle of water on untreated Nylon 6,6 plaques was 53°.

Treatment of Nylon 6,6 plaques in an analogous manner with a cerium oxide nanoparticle sol that lacked the NaNO₃ salt component resulted in no change in the receding contact angle of water on the treated plaques compared to receding contact angle of water on untreated plaques.

### EXAMPLE 14

A 0.1 wt % sol of nanoscale cerium oxide particles dispersed in deionized water was prepared and acidified to pH 1.5 with nitric acid. The cerium oxide particles of the sol exhibited an average particle size of about 10 nanometers by dynamic light scattering measurement The solution was further modified by the addition of 0.1 M sodium nitrate. Addition of salt did not change the dispersability of the nanoparticles. Teflon sample plaques were treated by submerging the plaques in the dispersion for 1 hour. These plaques were then removed from the solution and rinsed in deionized water. After rinsing the substrate was air dried and the hydrophilicity of the treated surfaces of the plaques was tested using contact angle measurements.

Receding contact angle (θᵣ) of water on Teflon plaques treated with cerium oxide nanoparticles in the presence of NaNO₃ was 51° while the receding contact angle of water on untreated Teflon plaques was 85°.

Treatment of Teflon plaques in an analogous manner with a cerium oxide nanoparticle sol that lacked the NaNO₃ salt component resulted in no change in the receding contact angle of water on the treated plaques compared to the receding contact angle of water on untreated plaques.

### EXAMPLE 15

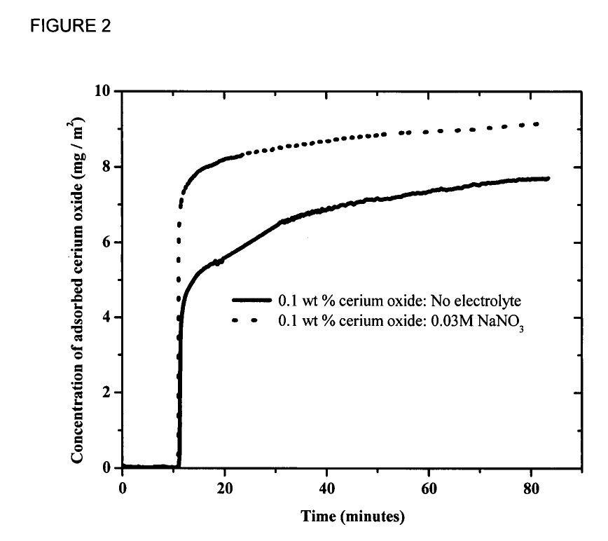

To demonstrate the presence of added electrolyte enhances the adsorption of nanoparticles on to a hydrophobic surface we present the results of light reflectance measurements that measure the concentration of adsorbed cerium oxide nanoparticles on polystyrene surfaces as a function of time. Details of the light reflectance technique can be found in the following paper (Dijt, J. C.; Cohen Stuart, M. A.; Fleer, G. J.; “Reflectometry as a tool for adsorption studies”; Adv. Colloid. Interface. Sci. 1994, 50, 79). In this measurement, a polystyrene surface was first equilibrated in deionized water for approximately 10 minutes to generate a flat baseline. After equilibration, a 0.1 wt % sol of nanoscale cerium oxide particles was introduced and the adsorption of the nanoparticles on the surface was measured as a function of time. The cerium oxide particles of the sol exhibited an average particle size of about 10 nanometers by dynamic light scattering measurement The data (shown in FIG. 2) show that the concentration of cerium oxide adsorbed on polystyrene increases by 30% when the nanoparticle sol contains 0.03M NaNO₃ compared to that obtained using an analogous sol that lacked the NaNO₃ component.

1. A surface modified substrate, comprising a substrate having a surface and a layer of nanoscale inorganic oxide particles disposed on at least a portion of the surface.

2. The surface modified substrate of claim 1, wherein the substrate is an organic polymer, an organosilicon polymer, a ceramic, a metal, a composite material, or an inorganic material other than a ceramic or metal.

3. The surface modified substrate of claim 1, wherein the substrate is an organic polymer.

4. The surface modified substrate of claim 3, wherein polymer is selected from polystyrene, polyethylene, polypropylene, polyethyleneterephthalate, nylon, and polytetrafluoroethylene.

5. The surface modified substrate of claim 1, wherein the substrate is a metal substrate.

6. The surface modified substrate of claim 1, wherein the substrate is an aluminum substrate.

7. The surface modified substrate of claim 1, wherein the nanoscale inorganic oxide particles comprise cerium oxide, titanium oxide, zirconium oxide, halfnium oxide, tantalum oxide, tungsten oxide and bismuth oxide, zinc oxide, indium oxide, and tin oxide, iron oxide.

8. The surface modified substrate of claim 1, wherein the nanoscale inorganic oxide particles comprise cerium oxide particles or silicon oxide particles.

9. The surface modified substrate of claim 1, wherein the nanoscale inorganic oxide particles are dispersed in a monolayer on the surface.

10. The surface modified substrate of claim 1, wherein surface is an aluminum surface and the nanoscale inorganic oxide particles comprise cerium oxide particles.

11. The surface modified substrate of claim 1, wherein the surface modified substrate is a hydrophilized substrate, comprising a substrate initially having a hydrophobic surface and a layer of nanoscale inorganic oxide particles disposed on at least a portion of such hydrophobic surface in an amount effective to increase the hydrophilicity of such portion of such hydrophobic surface.

12. The surface modified substrate of claim 1, wherein the surface modified substrate exhibits increases reactivity comprising a substrate initially having a relatively chemically inert surface and a layer of nanoscale inorganic oxide particles disposed on at least a portion of such surface in an amount effective to increase the chemically reactivity of such portion of such surface.

13. An article, comprising a surface modified substrate having a surface and a layer of nanoscale inorganic oxide particles disposed on at least a portion of the surface and a layer of a coating disposed on at least a portion of the layer of inorganic particles.

14. The article of claim 13, wherein substrate is an aluminum substrate, the nanoscale inorganic oxide particles comprise cerium oxide particles, and the layer of coating comprises an acrylic latex.

15. The article of claim 13, wherein substrate is an polymer substrate, the nanoscale inorganic oxide particles comprise cerium oxide particles, and the layer of coating comprises a printing ink.

16. A method for modifying the surface of a substrate, comprising treating at least a portion of such surface with a slurry of nanoscale inorganic oxide particles to deposit a quantity of such particles on such portion of such surface.

17. The method of claim 16, wherein the slurry is initially a stable dispersion nanoscale inorganic oxide particles in an aqueous medium, and the surface is treated by contacting the surface with the slurry and adjusting the pH of the slurry while the surface is in contact with slurry to precipitate nanoscale inorganic oxide particles from the slurry.

18. The method of claim 16, wherein the slurry comprises a stable dispersion of nanoscale inorganic oxide particles in an aqueous medium, the aqueous medium comprises a dissolved electrolyte, and the surface is treated by contacting the surface with the slurry and then discontinuing the contacting of the surface with the slurry.

19. The method of claim 18, wherein nanoscale inorganic particles comprise cerium oxide particles.

20. The method of claim 18, wherein the aqueous medium comprises from about 0.01 to about 0.1 percent by weight of the electrolyte.

21. The method of claim 18, wherein the electrolyte comprises a nitrate salt.

22. The method of claim 18, further comprising rinsing the treated surface with an aqueous rinse solution after discontinuing contacting of the surface with the stable slurry.
